(19) United States
(12) Patent Application Publication
(10) Pub. No.: US 2025/0195184 A1
(43) Pub. Date: Jun. 19, 2025

(54) System And Method Of Designing And Creating Dental Prostheses

(71) Applicant: Dalyn Dabney, Georgetown, TX (US)

(72) Inventor: Dalyn Dabney, Georgetown, TX (US)

(21) Appl. No.: 18/539,299

(22) Filed: Dec. 14, 2023

(51) Int. Cl. A61C 13/00; A61C 9/00

(52) U.S. Cl. CPC A61C 13/0019; A61C 9/0006; A61C 9/0053

(57) ABSTRACT

In some embodiments thereof, the present invention discloses systems and methods for expeditiously designing and fabricating properly-fitted dental prostheses. A customizable arch-shaped apparatus approximating dentition is employed intraorally to register positional and relational characteristics between maxillary and mandibular arches, including the vertical dimension of occlusion. The apparatus is configured to allow accurate interface with oral anatomy via its constituent material(s) being pliable and moldable preferably but not necessarily when heated. Representations of dentition may be integrated on the apparatus to aid proper positioning. Intraoral scan data detailing precise arch dimensions is either referenced from pre-existing patient records or procured through digital oral scanning of the apparatus in situ. The registered positional relationships and acquired scan data are jointly utilized to virtually model and subsequently manufacture bridgework, veneers or dentures; the apparatus allowing dentition to be modeled and fabricated in a singular office visit prior to a final, confirmatory try-in where minor adjustments may ensue.

### FIELD OF INVENTION

The present invention relates to systems and methods for producing precision fabricated dental prostheses such as dentures, partial dentures, bridges, and implants. More specifically, this disclosure pertains to the field of prosthodontics and the process of obtaining measurements using dental apparatus as well as the field of digitally mapping dental dimensions and anatomy for prosthesis fabrication.

### BACKGROUND OF THE INVENTION

Dental prosthetics, including full or partial dentures, bridges, and implants, play a crucial role in restoring oral function and aesthetics for individuals with missing or compromised teeth. Despite their importance, the current methods employed in fabricating these customized dental prostheses are fraught with challenges that impact both practitioners and patients. This background explores the existing art, delves into the intricacies of the time-consuming and iterative processes, examines the ramifications on patient well-being, acknowledges digital scanning limitations, and underscores the imperative need for a new system. The subsequent unveiling of the objectives of the current invention sheds light on its potential to revolutionize the landscape of prosthetic dentistry.

The field of prosthetic dentistry has made significant strides, yet the existing modalities are marred by inefficiencies and shortcomings. The conventional workflow stretches over several weeks, demanding extensive effort from dental practitioners. This protracted process results in diminished chair time availability, incurring both inefficiency and opportunity costs. The iterative nature obligates patients to undergo a series of appointments, from preliminary examinations to eventual appliance delivery. This not only proves burdensome but also introduces challenges like interim edentulousness, leading to disruptions in eating, speaking, and sleeping, and consequently affecting patients' nutritional status, communication abilities, and mental health.

The time-consuming nature of the current workflow is a bottleneck in prosthetic dentistry. It involves a series of appointments, each serving a specific purpose in the iterative process. Patients are required to attend a minimum of five appointments, each contributing to the gradual progression towards the final prosthesis. The process begins with a preliminary examination to assess the patient's oral anatomy and condition of remaining teeth. This is followed by impression taking, using conventional material-based methods or advanced digital scanning, to capture the geometry of the oral structures. With the impression or scan data, dental labs fabricate physical or digital models to begin preliminary design of the custom prosthesis. Patients later return for bite registration appointment using index materials to record proper occlusal relationships between upper and lower arches critical to prosthesis form and function. Subsequent try-in appointments involve evaluating interim prototypes, assessing areas of misfit relative to soft tissues or malocclusion, then iterating back to the lab for further adjustments. This elongated and incremental build-up not only strains the patience of patients but also poses workflow challenges for practitioners, tying up their time and resources over an extended period.

The extended duration of the iterative process has a tangible impact on patient well-being. The difficulties experienced during interim edentulousness, coupled with the inherent imperfections in capturing accurate occlusal relationships and anatomical contours, compromise the final prosthesis's form, function, and comfort. Patients endure disruptions in their daily lives, struggling with basic functions like eating, speaking, and sleeping due to unstable temporary prosthesis during treatment. Difficulty chewing and pain while wearing temporary denture negatively impacts patients' appetite. Along with gaining proper nutrition, patients note the inability to enunciate words clearly as an embarrassing social hindrance avoided by concealing their tooth loss. The combination of these physical impacts and emotional duress takes a toll on overall patient health and quality of life throughout the protracted weeks-long process.

While digital scanning has emerged as a promising alternative, it still falls short of offering an optimal solution. Digital scanning eliminates the need for traditional impression materials but remains only an intermediate step in an otherwise suboptimal workflow. The entire process, even with digital advancements, remains protracted, involving weeks and numerous patient visits. The promise of efficiency and precision with digital scanning is not fully realized within the current paradigm. Though digitization confers several advantages, the surrounding workflow and coordination with offsite dental laboratories continues to hamper rapid delivery of custom-fit prosthetics humans can comfortably wear and function with from initial exam to final placement.

The recognized limitations in the existing art underscore the critical need for a new system in prosthetic dentistry. A system that addresses the challenges of accurately registering occlusion dimensions, arch positions, and anatomical traits in an expedited manner is essential. The absence of such an integrated system perpetuates the inefficiencies and inconveniences associated with traditional methods.

As such, the current invention sets out to transform the landscape of prosthetic dentistry by addressing the deficiencies ingrained in existing methods. Firstly, the invention aims to streamline the fabrication process, significantly reducing the time required for designing and delivering dental prostheses. By consolidating and optimizing the workflow, it seeks to maximize practitioner efficiency and minimize opportunity costs. Secondly, the invention aims to alleviate the burdens imposed on individuals undergoing prosthesis fabrication. Through a reduced number of appointments and enhanced accuracy in capturing anatomical details, the invention aspires to enhance the overall patient experience. In leveraging a prefabricated apparatus and advanced recording techniques, the invention seeks to eliminate the inherent imperfections in capturing occlusal relationships and anatomical contours. The end result is a prosthesis that not only fits better but also functions optimally, addressing the shortcomings of existing methods.

### SUMMARY OF THE INVENTION

The following summary is an explanation of some of the general inventive steps for the invention in the description. This summary is not an extensive overview of the invention and does not intend to limit its scope beyond what is described and claimed as a summary.

In some aspects thereof, the present invention discloses an integrated system and associated methodologies to optimize the fabrication of precision-fit customized dental prostheses including full or part dentures, bridges, implants. A key inventive instrumentality enabling this transformation is a pliable, moldable arch-shaped apparatus mimicking natural dentition. Worn intraorally by the patient, the apparatus accurately registers maxillary and mandibular positional relationships critical for proper dental prosthesis form and function. These include occlusion dimensions between upper and lower arches in static contact and dynamic articulation. Integrated dentition-shaped components aid proper orienting inside the oral cavity.

In another aspect, with the apparatus in place, direct optical scanning or referenced pre-existing oral scan records provide high-fidelity input data on intraarch and interarch dimensions. The registered dimensional couplings and scan data are utilized synergistically to digitally model the dentition via CAD software for subsequent manufacturing processes. The resultant virtual model serves as the template for computer-aided machining of the final prosthesis via subtractive milling or additive 3D printing.

Further, a seminal advantage conferred is consolidating the entire workfow from initial modeling to final test fitting into a single patient office visit. This compares extremely favorably to current multi-visit methodologies requiring weeks for completion. Practitioner efficiency is enhanced via minimizing appointments while enhancing chair time utilization. Patients undergo dramatic process acceleration with fewer office visits requisite impressions, bite registrations and other time-consuming iterative steps obviated. Maximizing quality of life throughout treatment via the invention is thus achieved.

In a non-limiting embodiment, a confirmatory try-in finale allows minor adjustable to the delivered prosthesis before final insertion, ensuring ideal conformity and fit. Full integration of design, test fitting and manufacture combined with overall workflow streamlining finally fulfills the promise of digitally-enabled prosthetic dentistry through transformative efficiency and precision gains for practitioners and patients alike. All facets synergize to revolutionzie fabrication of dental prosthetics as demonstrated in reductions for office visits, workflow duration, material costs and manual effort required while amplifying precision, prosthesis performance and patient quality of life indicators.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 depicts the dental structure recording apparatus, representing the inventive instrumentality utilized in registering maxillary and mandibular positional relationships as well as taking dimensional measurements referenced for digital modeling and prosthesis fabrication.

FIG. 2 demonstrates the use of the dental structure recording apparatus intraorally to take direct optical impressions and capture critical anatomical traits of both arches including the occlusion interface.

FIG. 3 focuses on utilizing the apparatus to obtain shape, position and orientation details on a missing tooth space requiring prosthetic replacement, shown here as belonging to the mandibular arch but equally applicable to the maxillary.

FIG. 4 exhibits a virtual three-dimensional model of oral anatomy, generated by processing the measurement data captured through use of the dental structure recording apparatus. This CAD model facilitates engineering analysis for prosthesis design and serves as the digital template referenced during final manufacturing procedures.

FIG. 5 exhibits a dental prosthesis finalized for the patient based on the digitization, modeling, and manufacturing according to various aspects of the disclosed invention.

In a non-limiting aspect, the drawings and depictions above, conveying use of the apparatus both intraorally and for virtual dentition modeling requisite for producing well-fitting dental prostheses, are intended for illustration purposes and shall not constitute limitations on the scope or spirit of the invention itself based on the drawings or descriptions thereof. The methodology may apply to full or partial restorations across various intraoral sites.

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

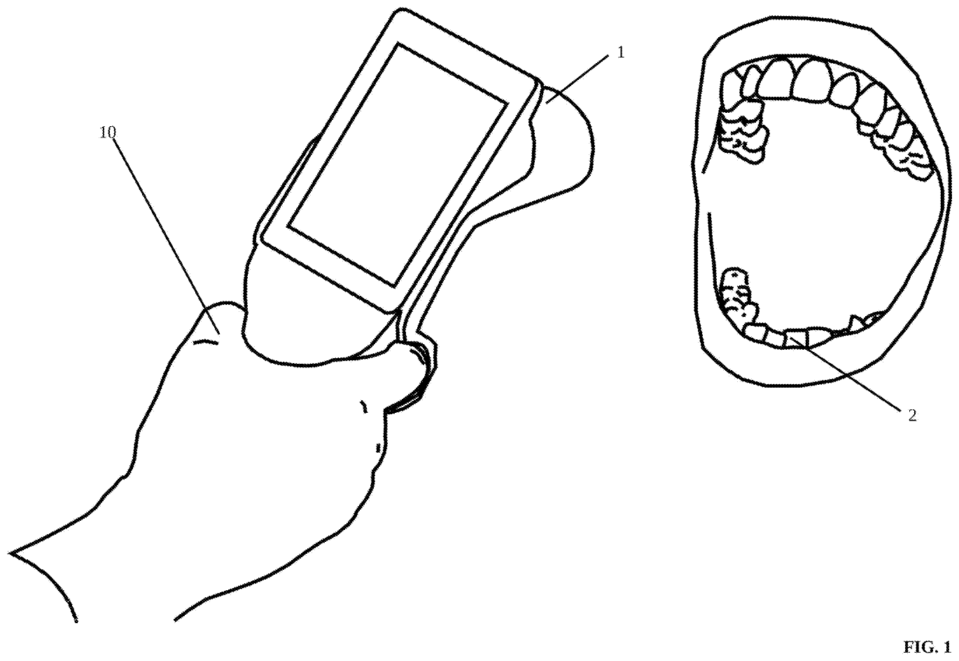

The non-limiting embodiment according to FIG. 1 illustrates a preferred embodiment of the dental structure recording apparatus 1, the primary inventive instrumentality enabling expedited recording of maxillary and mandibular anatomical traits required in dental prosthesis design and fabrication. The apparatus consists of a base conforming to dental arch dimensions containing integrated components interfacing with dentition. As depicted, the apparatus 1 is being held in the hand 10 of a practitioner or patient for placement inside the oral cavity overlaying the dental structure 2 of interest, shown here as the mandibular arch but equally applicably to the maxilla.

The dental structure recording apparatus 1 is comprised of materials imparting moldability and pliability, in particular when gently heated to temperatures suitable for intraoral use without discomfort or tissue damage. The contact surface interface of apparatus 1 is thus customizeable to match variances in bony anatomy and soft tissue topographies among individual dental structure 2 and arch shapes. Integrated components mimic natural dentition to assist positioning inside oral cavity in full occlusal contact with opposing teeth. The apparatus leverages material malleability to accurately conform to and record traits of the intended dental structure 2, capturing relative arrangements between anchored teeth and edentulous regions needing prosthetic remedies.

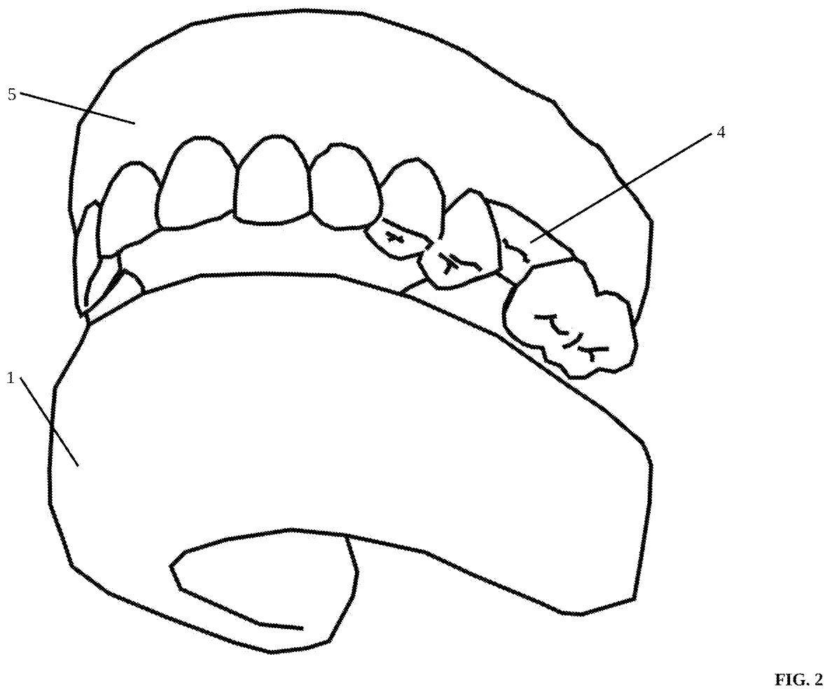

In another aspect, FIG. 2 demonstrates usage of the dental structure recording apparatus 1 following insertion into the oral cavity for direct in situ recording of anatomical details and occlusion. The moldable base now conforms to the dental structure 2 geometry with integrated components seated against existing dentition or edentulous 2 ridges in the case of missing tooth 4. Critical characteristics captured include shape of the alveolar ridge and adjacent soft tissues, position orientation of other anchored teeth, interarch relationships, and vertical dimension separating opposing jaws 5.

As depicted, the support structure 3 are utilized for support the impressioning layer for digital impressioning of the fitted dental structure recording apparatus 1. The scanning may alternatively reference archived oral anatomy data if pre-existing. The apparatus' integrated components provide accurate relative spatial relationships between known jaw positions and missing tooth 4 location needing prosthetic replacement. By this manner, all vital anatomical and positional reference linkages are registered rapidly during a single intraoral scanning session with the apparatus 1. The resultant digital data enables CAD modeling and associated manufacturing system to produce a well-fitting prosthetic solution tailored to missing tooth 4 dimensions within the localized ridge topography and in static/dynamic occlusion alignment with opposing dental structure 2 across jaws 5.

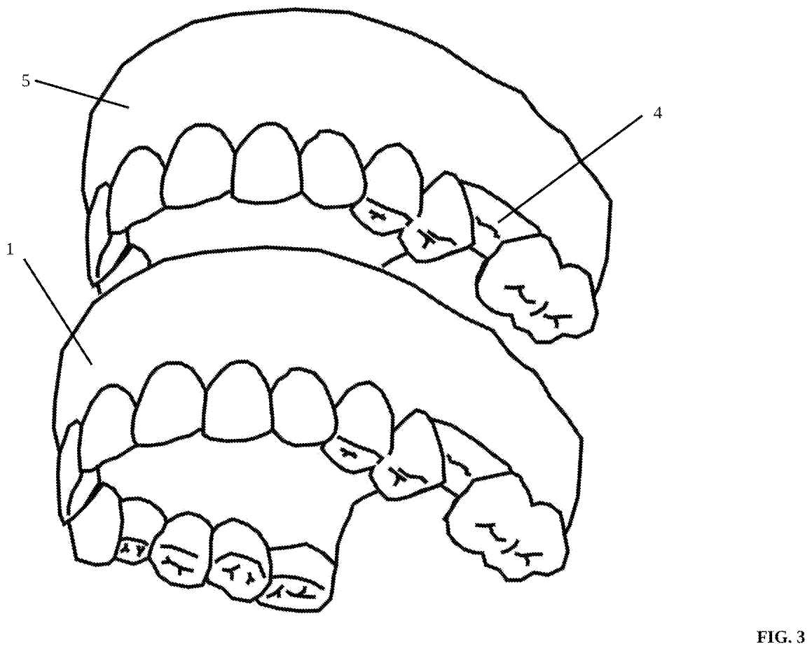

Further, the FIG. 3 exhibits the dental structure recording apparatus 1 deployed to capture critical details on a missing tooth space 4 requiring prosthetic replacement, in this case depicted as belonging to the mandibular arch though equally relevant for the maxillary. The integrated components of apparatus 1 now interface with adjacent in situ dentition and extend horizontally over the edentulous ridge. Vertically, the components span the distance from the incisal edges/cusp tips of anchors to the desired crown length of missing tooth 4 replacement.

With the apparatus 1 correctly seated against the alveolar bone topography, direct optical scanning or referenced archival oral scan data can pinpoint the precise three-dimensional coordinates and orientation of missing tooth 4 space relative to anchored dentition and opposing occlusion alignment. As shown, the missing tooth measurement markers 6 indicate the mesial-distal and buccal-lingual/palatal extent targeted for the prosthetic solution, ensuring proper structural and aesthetic restoration. The moldable adaptability of apparatus 1 directly captures the curvature and position of the residual alveolar bone itself. Collectively, the detailed nuances captured via the stabilized recording apparatus 1 mitigate traditional methods of tedious direct intraoral measurements, bite registrations and iterative fittings-enabling expedited precision manufacturing of the replacement prosthetic.

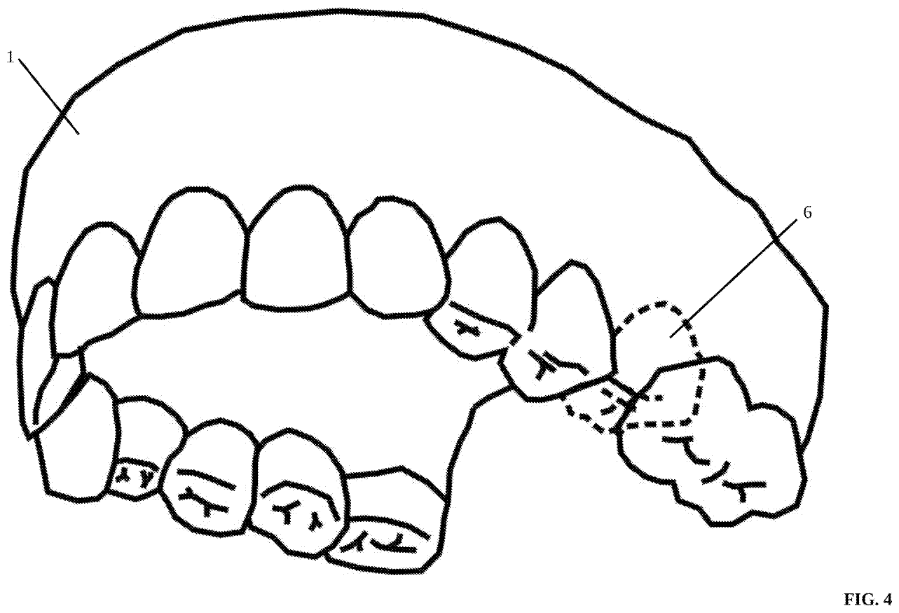

The embodiment according to FIG. 4 demonstrates a computer-generated virtual three-dimensional model 7 of the oral anatomy, fabricated by processing dimensional and positional data garnered from use of the dental structure recording apparatus 1 intraorally as depicted in preceding drawings. The captured measurements quantify traits of existing dentition, edentulous sites, and interarch spatial relationships. As illustrated, this includes precise coordinates mapped to the missing tooth space 4 obtained via missing tooth measurement markers 6 which delineated target crown dimensions for prosthetic replacement.

The aggregated data inputs are converted by CAD software into customizable digital models 7 accurate down to milliliter-scale spatial precision of anatomic structures. The models facilitate parametric analysis, design provisioning, dynamic simulation of occlusion, and refinement of prosthesis morphology specialized for the patient. Output STL data from finalized model 7 can be transmitted directly to CAM machining centers to initiate additive or subtractive manufacturing procedures for the personalized prosthesis. By utilizing the dental structure recording apparatus 1 as shown to capture myriad intraoral data inputs for CAD, subsequent production of exceptionally well-fitting dental prostheses is eminently achievable. The apparatus 1 thereby functions as vital connective tissue bridging real-world analog dimensions to digital model 7 outputs.

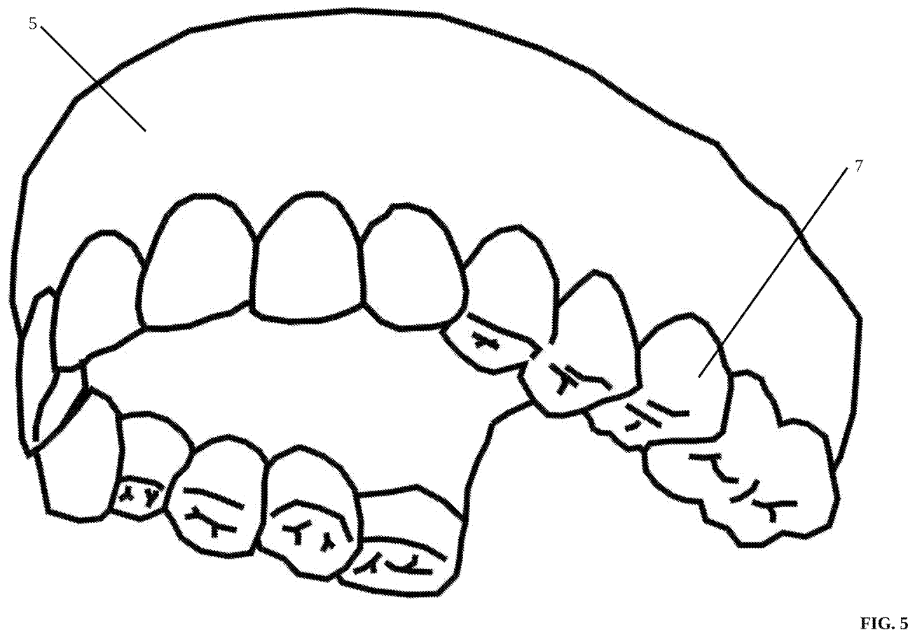

The last shown embodiment according to FIG. 5 exhibits a dental prosthesis 8 finalized for the patient based on the digitization, modeling, and manufacturing pipeline enabled by the inventive dental structure recording apparatus. As shown, the customized prosthetic solution is depicted here as worn by the user, exemplifying the proper fit and function achieved by the apparatus-to-production workflow for precise replication of the intended oral anatomical form and occlusion alignment. This figure represents the final stage of the transformative process conferred by the invention, where a patient can promptly regain dental aesthetics and critical physiological capabilities through a perfectly sized and shaped prosthesis.

Embodiments of the moldable dental prosthesis recording apparatus may utilize a variety of materials for constructing the base portion and integrated components which interface with tooth surfaces when seated intraorally. The pliable materials adapted to conform to dental structures include but are not limited to waxes, acrylics, plastics, polymers, and combinations thereof selected for deformation properties allowing molding under mild heating without discomfort or tissue injury.

Alternative embodiments may selectively specify composition materials for the base portion verses the attached components to either match or differ in mechanical traits such as malleability, hardness, elasticity and plasticity in response to thermal actuation for custom molding against dental arch anatomy. Additional embodiments also encompass dental prosthesis recording apparatuses configurable in a multiplicity of base portion lengths, widths, curvatures, and patterns of integrated surface-contacting components thereon to enable selection of specific arch dimension configurations matched to individual patient anatomy.

Embodiments of the method for expedited design and delivery of dental prostheses include, but are not limited to, the moldable arch-shaped recording apparatus being heated using non-limiting means such as hot water bath immersion or intermittent air convection to increase apparatus pliability and adaptability for intraoral positioning and conformance to anatomy. Additionally covered alternatives relate to the encompassing of spatial anatomical recordings and dimensional measurements using optical mechanical coordinate-mapping probes, radio frequency surface digitization or other tangible signal/waveform reflecting techniques allowing digitization of oral cavity structures.

And while preferred embodiment methods transform the captured data sets into virtual three-dimensional solid models for visual analysis and manufacturing system integration, alternative embodiments utilize the raw data itself, processed into specialized file formats compatible with specific dental CAD environments or production workflows, without strictly requiring an intermediate VR model. Method alternatives also extend to optical, ultrasonic, adhesive or mechanical fixturing of the recording apparatus stable intraorally to ensure motion-free capturing of static and dynamic spatial recordings and measurements.

Further, while a preferred embodiment of this invention has been described for illustrative purposes, it should be noted that this invention is not limited to the described embodiment, and those skilled in the art will recognize that various modifications, additions, and substitutions may be necessary or beneficial for this particular application, all of which remain within the scope and spirit of the invention as defined by the accompanying claims. The applicant acknowledges and anticipates such adjustments.

Consequently, the applicant intends to encompass all such alternative designs, modifications, equivalents, and variations that fall within the essence and scope of the disclosed subject matter, specifically tailored for this application. It is also important to recognize that references to items in singular form encompass items in plural form, and vice versa, unless explicitly stated otherwise or evident from the context.

Grammatical conjunctions are used to denote both disjunctive and conjunctive combinations of conjoined clauses, sentences, words, and the like, unless otherwise specified or evident from the context.

Use of singular or plural terms is meant to encompass all options, unless explicitly limited. The term “or” in particular implies “and/or” except where otherwise indicated.

### INDUSTRIAL APPLICATION

The disclosed invention finds industrial applications in design and manufacturing of customized dental prostheses. Industrial producers from large centralized mills to small clinical labs can utilize the disclosed techniques to minimize production costs, overheads and material waste while maximizing productivity. Patients also benefit from this reinvented workflow via lower wait times and faster recovery of oral function. The invention thus creates a win-win proposition benefiting dental labs, clinics and patients through an optimized balance of digitization and tailored material instrumentations for the next generation of efficient precision prosthetic dentistry solutions. This unique blending of technologies signifies an industry-wide leap towards higher quality and consistent on-demand mass customization at scale.

What is claimed is:

1. A system for registering measurements and relationships of dental structures comprising:
a moldable dental prosthesis recording apparatus positioned intraorally, said apparatus having a base portion sized and shaped to overlay a dental arch and a plurality of integrated components arranged to interface with tooth surfaces;
wherein the base portion and integrated components are comprised of one or more pliable materials adaptable to conform to said dental structures.

2. The system of claim 1 wherein said integrated components mimic natural dentition shapes and arrangements to allow a practitioner to relate the apparatus to dental and facial features thereby registering these relationships for fabrication of a dental prosthesis.

3. The system of claim 1 further comprising means for controlling the temperature of said pliable materials to adaptability conform to individual anatomical variances, wherein said means utilizes water, air or other methods for increasing or decreasing the temperature of the apparatus.

4. The system of claim 1 wherein the apparatus further comprises one or more fiducial markers integrated within the base portion or integrated components readable by a scanning apparatus.

5. The system of claim 1 wherein the pliable materials comprise wax, acrylic, plastic, polymer or combinations thereof deformable under mild heating.

6. The system of claim 1 wherein dimensions of the base portion including length, width, curvature and patterns of integrated components thereon are specifiable to match dental arch dimensions, and wherein the apparatus is adjustable or modifiable by a practitioner to further adapt said dimensions and patterns to dental structures.

7. A moldable dental prosthesis recording apparatus positioned intraorally for registering measurements and relationships of dental structures comprising:
a base portion sized and shaped to overlay a dental arch;
a plurality of integrated components arranged to interface with tooth surfaces; and
said base portion and plurality of integrated components comprised of one or more pliable materials adaptable to conform to said dental structures.

8. The apparatus of claim 7, wherein said integrated components mimic natural dentition shapes and arrangements to allow a practitioner to relate the apparatus to dental and facial features thereby registering these relationships for fabrication of a dental prosthesis.

9. The apparatus of claim 7 further comprising means for controlling the temperature of said pliable materials to adaptability conform to individual anatomical variances, wherein said means utilizes water, air or other methods for increasing or decreasing the temperature of the apparatus.

10. The apparatus of claim 7 further comprising one or more fiducial markers integrated within the base portion or integrated components readable by a scanning apparatus.

11. The apparatus of claim 7, wherein the pliable materials comprise wax, acrylic, plastic, polymer or combination thereof deformable under mild heating.

12. The apparatus of claim 7, wherein dimensions of the base portion including length, width, curvature and patterns of integrated components thereon are specifiable to match dental arch dimensions.

13. The apparatus of claim 7, wherein said base portion and integrated components are adjustable or modifiable by a practitioner to further adapt the apparatus as needed.

14. A method for expedited design and manufacture of a dental prosthesis utilizing a moldable intraoral recording apparatus comprising:
heating said moldable recording apparatus to increase pliability;
positioning the heated apparatus within an oral cavity overlaying a dental arch and adjacent existing dentition;
adapting the apparatus to conform to dental structures;
recording spatial relationships and obtaining measurement data while apparatus is stabilized intraorally;
processing captured recordings and measurement data to virtually model the dentition; and
outputting the virtual model for production of said dental prosthesis therewith.

15. The method of claim 14 further comprising representing dentition morphology patterns on said moldable recording apparatus via integrated components to assist positioning intraorally.

16. The method of claim 14 wherein recorded spatial relationships comprise dental arch and occlusion alignment positional linkages.

17. The method of claim 14 wherein obtained measurement data specifies coordinates and orientations of tooth gaps targeted for prosthetic insertion.

18. The method of claim 14 wherein processing captured recordings and measurements transforms analog dimensions into three-dimensional digital models of oral anatomy.

19. The method of claim 14 further comprising iteratively refining the virtual model by simulation of dynamic occlusion and other dentition movements.

20. The method of claim 14 wherein outputting transmits model data to manufacturing systems based on computer-aided machining or 3D printing.
